(19) United States
(12) Patent Application Publication
(10) Pub. No.: US 2008/0260614 A1
(43) Pub. Date: Oct. 23, 2008

(54) Process for Producing Carbonate Particles

(75) Inventor: Kawano Tetsuo, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/660,948

(22) PCT Filed: Aug. 23, 2005
(86) PCT No.: PCT/JP05/15294

§ 371 Date: Apr. 4, 2007

(30) Foreign Application Priority Data
Aug. 25, 2004 (JP) 2004-245116
Jul. 29, 2005 (JP) 2005-222081

(51) Int. Cl. C01B 31/24

(52) U.S. Cl. 423/430

(57) ABSTRACT

To provide a process for producing carbonate particles, particularly carbonate particles that are needle- or rod-shaped, which can efficiently and readily form carbonate particles which offer orientation birefringence without heating at approximately room temperature, and can control the particle size. In the process, a carbon dioxide gas from a carbonate source is released into the gas phase and the carbon dioxide gas is dissolved in a liquid containing a metal ion source to produce carbonate particles which have an aspect ratio of greater than 1, wherein the metal ion source contains at least one metal ion selected from the group consisting of Sr²⁺, Ca²⁺, Ba²⁺, Zn²⁺ and Pb²⁺. The carbonate particles are preferably needle- or rod-shaped, the metal ion source is a hydroxide of a metal such as Sr, the carbon dioxide gas is released in a closed vessel, and the liquid contains a solvent.

### TECHNICAL FIELD

The present invention relates to a process for producing carbonate particles, particularly carbonate particles that are needle- or rod-shaped, which can efficiently and readily form carbonate particles which offer orientation birefringence, without heating at 50° C. or more, at approximately room temperature, and can control the particle size.

### BACKGROUND ART

Carbonates (e.g., calcium carbonate) have been widely used in various fields including rubber, plastic, and paper. In recent years high-performance carbonates have been increasingly developed and are used for many purposes according to their specific features such as particle shape and diameter.

Calcite, aragonite and vaterite are the examples of the crystalline forms of carbonate. Of the three, aragonite is useful in many applications because it is composed of needle-shaped particles and thereby offers excellent strength and elastic modulus.

For example, generally known processes for carbonate production are: a process in which carbonate ion-containing solution is reacted with chloride-containing solution; and a process in which a chloride is reacted with carbonic acid gas. In addition, there are processes that are proposed for the production of needle-shaped carbonates with an aragonite-like structure: a process in which carbonate ion-containing solution is reacted with chloride-containing solution under application of ultrasonic wave (see Patent Document 1); a process for introducing carbon dioxide into aqueous slurry of Ca(OH)₂, in which a needle-shaped aragonite crystal is previously introduced in the aqueous slurry as a seed crystal followed by growing of the seed crystal in a given direction (see Patent Document 2); a process in which sodium aluminate is added to calcium hydroxide slurry and heated at 50° C. or more, and then a carbon dioxide gas is charged thereto (see Patent Document 3).

The production process disclosed in Patent Document 1, however, has a problem that its use results in the formation of large carbonate particles of 30 μm to 60 μm in length with a broader particle size distribution, which makes it impossible to produce carbonate particles with a desired, controlled size. Also, the use of the production process disclosed in Patent Document 2 merely results in the formation of large carbonate particles of 20 μm to 30 μm in length. The production process disclosed in Patent Document 3 needs to be controlled by heating during a production process.

Meanwhile, there is a strong tendency in recent years that polymer resins are increasingly used for general optical components (e.g., glass lenses and transparent plates) and optical components designed for optoelectronics, particularly for materials of optical components of laser-related devices used for instance in optical disc apparatus for recording of sounds, pictures, texts, and the like. One of the reasons for this is that optical polymer materials (optical materials made of polymer resin) are generally excellent in terms of lightness, cost, processibility and productivity compared to other optical materials such as optical glass. In addition, polymer resins are advantageous because molding techniques, such as extrusion molding or injection molding, can be readily applied.

However, molded articles formed from such conventional, general optical polymer material by means of any of the molding techniques are known to show birefringence. Although the optical polymer materials that offer birefringence are not especially problematic when used in optical elements that do not require so high optical precision, there is a high demand in recent years for high-precision optical articles. For example, birefringence causes a serious problem in rewritable magneto optical discs. That is, since such a magneto optical disc utilizes a polarized beam as a reading or a recording beam, the presence of a birefringent element (e.g., the disc itself or a lens) in an optical path affects the precision of reading or recording of information.

To reduce the degree of birefringence to avoid this problem, there is proposed a non-birefringent optical resin material formed from inorganic particles and polymer resin, the birefringence values of which are of opposite sign (see Patent Document 4). The optical resin material is prepared by the process called crystal doping. More specifically, a number of inorganic particles are dispersed in polymer resin, and a molding force is applied from the outside by drawing or the like, allowing linking chains present in the polymer resin and the inorganic particles to align in a direction that is substantially parallel to each other, so that the birefringence due to the optical anisotropy of the linking chains is canceled by the birefringence of the inorganic particles, which the value is the opposite sign.

In a case where a non-birefringent optical resin material is to be prepared by crystal doping, it is imperative to adopt inorganic particles that are applicable to crystal doping. It is recognized that fine carbonate particles that have needle or rod shapes are particularly suitable for such inorganic particles.

Patent Document 1: Japanese Patent Application Laid-Open (JP-A) No. 59-203728

Patent Document 2: U.S. Pat. No. 5,164,172

Patent Document 3: Japanese Patent Application Laid-Open (JP-A) No. 8-2914

Patent Document 4: International Publication No. WO 01/25364

### DISCLOSURE OF THE INVENTION

It is an object of the present invention to provide process for producing carbonate particles, particularly carbonate particles that are needle- or rod-shaped, which can efficiently and readily form carbonate particles which offer orientation birefringence without heating at approximately room temperature, and can control the particle size.

The present inventor has conducted extensive studies to overcome the foregoing problems and established that by releasing a carbon dioxide gas from a carbonate source such as ammonium carbonate into a gas phase, and dissolving the released carbon dioxide gas in a liquid containing a metal ion source containing metal ions such as Sr²⁺ and/or Ca²⁺, it is possible to efficiently and readily produce carbonate particles, particularly carbonate particles that are needle- or rod-shaped, which have an aspect ratio of greater than 1, without heating at approximately room temperature, while controlling their particle size.

The present invention has been accomplished based on the foregoing findings of the present inventor. The means to overcome the foregoing problems are as follows:

<1> A process for producing carbonate particles, containing: releasing a carbon dioxide gas from a carbonate source into a gas phase, dissolving the carbon dioxide gas in a liquid containing a metal ion source to produce carbonate particles having an aspect ratio of greater than 1, wherein the metal ion source contains at least one metal ion selected from the group consisting of Sr²⁺, Ca²⁺, Ba²⁺, Zn²⁺ and Pb²⁺. In the process according to <1> the carbon dioxide gas from the carbonate source is released into the gas phase. The carbon dioxide gas released into the gas phase is dissolved in the liquid containing the metal ion source. At the moment, the carbon dioxide gas is diffused slowly and dissolved in the liquid. As a result, the carbonate particles having an aspect ratio of greater than 1 are produced.

<2> The process for producing carbonate particles according to <1>, wherein the carbonate particles are needle- or rod-shaped. In the process according to <2> carbonate particles that are needle- or rod-shaped are produced, which can be used for many applications including non-birefringent optical resin materials.

<3> The process for producing carbonate particles according to any one of <1> and <2>, wherein the metal ion source is at least one hydroxide of a metal selected from the group consisting of Sr, Ca, Ba, Zn, and Pb. In the process according to <3> the carbonate particles are synthesized in high alkali region, because the metal ion source is the hydroxide of the metal. As a result, the fine carbonate particles having a high aspect ratio are produced.

<4> The process for producing carbonate particles according to any one of <1> to <3>, wherein the carbonate source is in a solid state or a gas state.

<5> The process for producing carbonate particles according to <4>, wherein the carbonate source is a solid ammonium carbonate.

<6> The process for producing carbonate particles according to any one of <1> to <5>, wherein the carbon dioxide gas is released in a closed vessel.

<7> The process for producing carbonate particles according to <6>, wherein the closed vessel is configured to be able to control the release pressure of the carbon dioxide gas.

<8> The process for producing carbonate particles according to any one of <1> to <7>, wherein the liquid contains water.

<9> The process for producing carbonate particles according to any one of <1> to <8>, wherein the liquid contains a solvent. In the process according to <9> the solvent is contained. For this reason, the solubility of the resulting carbonate can be reduced.

<10> The process for producing carbonate particles according to <9>, wherein the solvent is at least one selected from the group consisting of methanol, ethanol, and isopropyl alcohol.

According to the present invention, it is made possible to solve the foregoing conventional problems and to provide a process for producing carbonate particles, particularly carbonate particles that are needle- or rod-shaped, which can efficiently and readily form carbonate particles which offer orientation birefringence without heating at approximately room temperature, and can control the particle size.

### BRIEF DESCRIPTION OF THE DRAWINGS

FIG. 1 is a conceptual view for explaining an example of the process for producing carbonate particles of the present invention.

FIG. 2A is a graph showing a relation between pH of strontium hydroxide suspension and elapsed time in Example 1.

FIG. 2B is an SEM picture of strontium carbonate crystals prepared in Example 1

FIG. 3A is an SEM picture (magnification: 1,020) of strontium carbonate crystals prepared in Comparative Example 1.

FIG. 3B is an SEM picture (magnification: 5,030) of strontium carbonate crystals prepared in Comparative Example 1.

### BEST MODE FOR CARRYING OUT THE INVENTION

### (Process for Producing Carbonate Particles)

The process for producing carbonate particles of the present invention is a process in which a carbon dioxide gas from a carbonate source is released into a gas phase, and the carbon dioxide gas released into the gas phase is dissolved in a liquid containing a metal ion source to produce carbonate particles having an aspect ratio of greater than 1.

### —Carbonate Source—

The carbonate source is not particularly limited as long as it produces a carbon dioxide gas and can be appropriately selected depending on the intended purpose. It may be preferably in a solid state or a gas state.

The carbonate source in the solid state is not particularly limited and can be appropriately selected depending on the intended purpose; for example, ammonium carbonate ((NH₄)₂CO₃) is preferable.

The carbonate source in the gas state includes the carbon dioxide gas.

### —Metal Ion Source—

The metal ion source is not particularly limited as long as it contains metal ions and can be appropriately selected depending on the intended purpose; however, those that produce a carbonate with a crystalline form of any of calcite, aragonite and vaterite or amorphous form by reaction with the carbonate gas are preferable. Among these, the metal ion source that produces a carbonate with an aragonite-type crystal structure is particularly preferable.

The crystal structure of the aragonite type-carbonate is represented by the metal ion and the CO₃²⁻ unit, which are agglomerated one after another to form carbonate particles having needle- or rod-shapes. Thus, when the carbonate is added to a polymer film and the like, the carbonate is drawn in a given direction by a drawing process to be described later, and then, crystals are arranged with the longitudinal axes of the particles being parallel to the stretch direction.

Table 1 shows refractive indexes of some aragonite-type minerals. As shown in Table 1, carbonates with the aragonite-type crystal structure all have larger birefringence δ. Thus, they are preferably doped into polymers that offer orientation birefringence.

TABLE 1

| | | | | | Specific |
|---|---|---|---|---|---|
| | α | β | γ | δ | Density |
| CaCO₃ | 1.530 | 1.681 | 1.685 | 0.155 | 2.94 |
| SrCO₃ | 1.520 | 1.667 | 1.669 | 0.149 | 3.75 |
| BaCO₃ | 1.529 | 1.676 | 1.677 | 0.148 | 4.29 |
| PbCO₃ | 1.804 | 2.076 | 2.078 | 0.274 | 6.55 |

The metal ion source is not particularly limited as long as it contains at least one metal ion selected from the group consisting of Sr²⁺, Ca²⁺, Ba²⁺, Zn²⁺ and Pb²⁺, and can be appropriately selected depending on the intended purpose; examples include nitrates, chlorides, hydroxides, etc., of at least one metal selected from the group consisting of Sr, Ca, Ba, Zn and Pb. Of these, the hydroxide of the metal is particularly preferable. If the metal ion source is the hydroxide of the metal, carbonate particles are synthesized in a high alkali region, which results in high aspect ratio and fine carbonate particles.

A liquid containing the metal ion source preferably contains water. Accordingly, such a liquid containing the metal ion source is preferably an aqueous solution or a suspension.

Moreover, it is preferable to add a solvent in the liquid for the purpose of reducing the solubility of the resulting carbonate crystals.

The solvent is not particularly limited and can be appropriately selected depending on the intended purpose; suitable examples include methanol, ethanol and isopropyl alcohol. These solvents may be used singly or in combination.

In addition, the added amount of the solvent is not particularly limited and can be appropriately set depending on the intended purpose; the content of such a solvent is preferably 1% by volume to 80% by volume, more preferably 10% by volume to 80% by volume of the solvent in the solution after production of carbonate particles.

The process of releasing the carbon dioxide gas into the gas phase is not particularly limited can be appropriately selected depending on the intended purpose; the carbon dioxide gas is preferably released in a closed vessel.

The process of dissolving the carbon dioxide gas into the liquid containing the metal ion source is not particularly limited and can be appropriately selected depending on the intended purpose; for example, the carbon dioxide gas is preferably diffused slowly to dissolve in the liquid containing the metal ion source.

The liquid containing the metal ion source and the carbonate source are preferably housed in a closed vessel.

The manner of housing the liquid containing the metal ion source and the carbonate source in the closed vessel is not particularly limited and can be appropriately selected depending on the intended purpose; for example, in the case of the solid carbonate source, it may be placed on the base of the closed vessel, on the side, or hung from the upper surface.

The closed vessel is preferably configured to be able to control the release pressure of the carbon dioxide gas.

The manner of controlling the release pressure of the carbon dioxide gas is not particularly limited and can be appropriately selected depending on the intended purpose; for example, the release pressure of the carbon dioxide gas is preferably set in order that a desired mass of the carbon dioxide gas may be dissolved in the liquid containing the metal ion source on the basis of Henry's law.

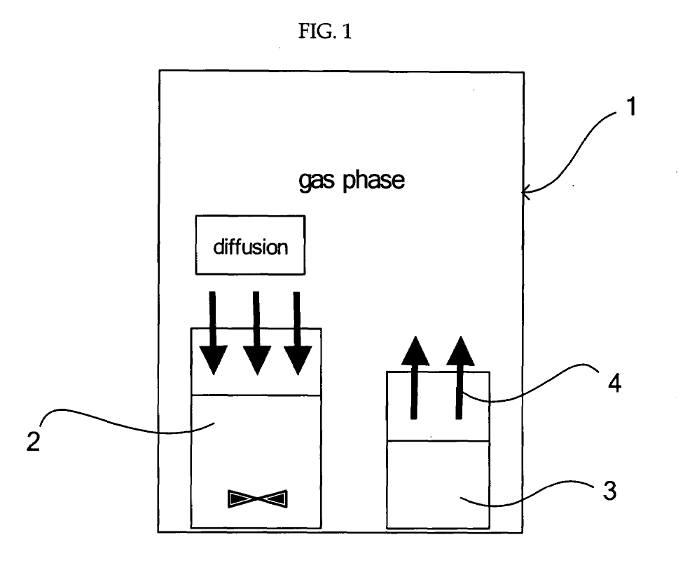

A process for producing carbonate particles of the present invention will be exemplified when the carbonate source is in a solid state. For example, as shown in FIG. 1, a liquid containing the metal ion source 2 is placed in a (closed) vessel 1, and a carbonate source 3 is also placed on the bottom of the (closed) vessel 1. Then, a carbon dioxide gas 4 is generated and released from the carbonate source 3 into a gas phase in the (closed) vessel 1. The carbon dioxide gas 4 which is released into the gas phase is diffused slowly to dissolve in the liquid containing the metal ion source 2. As a result, the metal ion in the liquid containing the metal ion source 2 reacts with the carbonate ion generated from the carbon dioxide gas 4 dissolved in the liquid containing the metal ion source 2, and then carbonate particles are produced.

The synthesis reaction of the carbonate particles when the metal ion source is Sr(OH)₂ will be explained hereinbelow.

Carbonate ion (CO₃²⁻) which is generated by dissolving the carbon dioxide gas in the liquid (aqueous solution) containing the metal ion source and ionized strontium ion (Sr²⁺) are reacted as the following formula (I) and strontium carbonate (SrCO₃) as the carbonate particles is synthesized.

Sr²⁺+CO₃²⁻→SrCO₃ Formula (I)

The reaction temperature in the synthesis reaction is not particularly limited and can be appropriately selected depending on the intended purpose. The carbonate particles can be synthesized at the range from room temperature to 50° C. or less, and preferably at 25° C., approximately room temperature.

The reaction time is not particularly limited and can be appropriately set depending on the intended purpose; however, the reaction time is preferably 15 minutes to 360 minutes, and more preferably 30 minutes to 240 minutes.

The synthesis reaction is preferably conducted with agitating the liquid containing metal ion source, and the agitation speed is preferably 500 rpm to 1,500 rpm.

### —Physical Properties of Carbonates—

The carbonate particles produced by the process of the present invention need to have an aspect ratio of greater 1, and preferably have needle- or rod-shapes.

The aspect ratio means the ratio of the length of a carbonate particle to its diameter; the greater the aspect ratio, the more preferable. The aspect ratio is preferably 1.5 to 20, and more preferably 1.5 to 8.

The average particle length of the carbonate particles is preferably 0.05 μm to 30 μm, more preferably 0.05 μm to 5 μm. An average particle length of greater than 30 μm may result in greater influences of light scattering, which may reduce its practical applicability to optical purposes.

The proportion of carbonate particles having a length of “average particle length ±α” in the total carbonate particles is preferably 60% or more, more preferably 70% or more, still more preferably 75% or more, and particularly preferably 80% or more. A proportion of 60% or more means that the particle size has been precisely controlled.

Here “α” is preferably 0.05 μm to 2 μm, more preferably 0.05 μm to 1.0 μm, still more preferably 0.05 μm to 0.8 μm, and particularly preferably 0.05 μm to 0.1 μm.

### —Applications—

In the case of the carbonate particles produced by the process of the present invention, variations in the orientation of particles in the resulting molded article are small and thus the mold article becomes isotropic, making it useful for reinforcing materials for plastics, frictional materials, heat insulating materials, filters, and the like. When the carbonate particles are used for shape-changed composite materials such as drawn materials, aligned particles therein can increase their strength, and improve their optical characteristics.

Moreover, when the carbonate particles, or carbonate crystals, produced by the process of the present invention are dispersed into an optical polymer having a birefringence, followed by a drawing process for allowing linking chains present in the optical polymer and the carbonate crystals to align in a direction substantially parallel to each other, the birefringence due to the optical anisotropy of the linking chains can be canceled by the birefringence of the carbonate crystals.

The drawing process is not particularly limited and can be appropriately selected depending on the intended purpose; for example, uniaxial drawing can be used. In a case of uniaxial drawing, for example, a drawing machine is used to draw an article to a desired magnification under heat where necessary.

Inherent birefringences of some optical polymers are shown by Ide Fumio “Transparent Resins—High-Performance Optical Materials Challenging IT World”, Kogyo Chosakai Publishing, Inc., 1st ed., p. 29 as listed in the following Table 2. It can be learned from Table 2 that most optical polymers have a positive birefringence value. When strontium carbonate as the foregoing carbonate is added to polycarbonate as the optical polymer, the positive birefringence of the mixture can be reduced to 0, or even under 0. For this reason the optical polymer added with such carbonate particles can be suitably used for optical components, particularly optical elements where polarization characteristics are of importance and high precision is required.

TABLE 2

| Polymers | Inherent Birefringence |
|---|---|
| Polystyrene | −0.10 |
| Polyphenylene ether | 0.21 |
| Polycarbonate | 0.106 |
| Polyvinyl chloride | 0.027 |
| Polymethyl methacrylate | −0.0043 |
| Polyethylene terephthalate | 0.105 |
| Polyethylene | 0.044 |

According to the process for producing carbonate particles of the present invention, it is possible to efficiently and readily produce carbonate particles, particularly carbonate particles that are needle- or rod-shaped, offer an orientation birefringence without heating at 50° C. or more, at approximately room temperature. It is also possible to control the particle size to obtain a high proportion of carbonate particles of a certain size.

Hereinafter, the present invention will be described with reference to Examples and Comparative Examples, which however shall not be construed as limiting the invention thereto.

### EXAMPLE 1

### Preparation of Carbonate Particles

As shown in FIG. 1, a vessel containing 10 ml of 0.01 M strontium hydroxide (Sr(OH)₂) suspension (pH of 12.2) as a liquid containing a metal ion source and a solid ammonium carbonate ((NH₄)₂CO₃) as a carbonate source were placed in a closed vessel. Then, a carbon dioxide gas was generated and released from ammonium carbonate ((NH₄)₂CO₃) into the gas phase in the closed vessel. The carbon dioxide gas released into the gas phase was slowly diffused and dissolved in a strontium hydroxide (Sr(OH)₂) suspension while agitating the strontium hydroxide (Sr(OH)₂) suspension at a reaction temperature of 25° C. for 360 min. to be reacted with the carbon dioxide gas, thereby obtaining strontium carbonate crystals as carbonate crystals. The pH of the liquid containing the strontium carbonate crystal was 9.4 at the completion of the reaction. The agitation was conducted at 500 rpm.

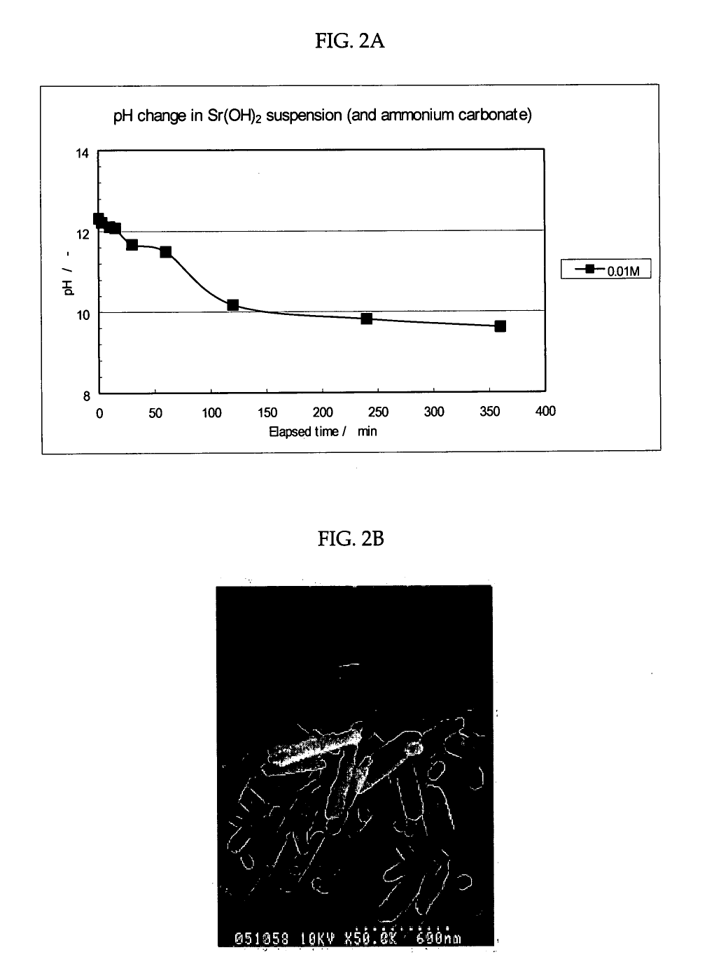

The relation between pH of the strontium hydroxide (Sr(OH)₂) suspension and elapsed time is shown in FIG. 2A. The pH is 12.2 at the beginning of the reaction, and then after 360 min. the pH is 9.4 at the completion of the reaction. It was confirmed that the pH of the strontium hydroxide (Sr(OH)₂) suspension was reduced by dissolving the carbon dioxide gas.

The strontium carbonate crystals thus produced were recovered by filtration and dried. The dried strontium carbonate crystals were observed using a scanning electron microscope (SEM) (S-900 by Hitachi Ltd.). An SEM picture taken at this time is shown in FIG. 2B. From this picture it was confirmed that strontium carbonate crystals were obtained that have pillar (rod) shapes, and have an average particle length of around 470 nm. In addition, the proportion of crystals with a length of average particle length a (where a is 50 nm) in the total crystals was 67%. The results are shown in Table 3.

### EXAMPLE 2

### Preparation of Carbonate Particles

Carbonate (calcium carbonate) crystals were produced in a manner similar to that described in Example 1, with a 0.01M calcium hydroxide (Ca(OH)₂) suspension used instead of the 0.01M strontium hydroxide (Sr(OH)₂) suspension. The calcium carbonate crystals thus produced were observed using the SEM. The measurement results of various parameters are shown in Table 3.

### EXAMPLE 3

### Preparation of Carbonate Particles

Carbonate (strontium carbonate) crystals were produced in a manner similar to that described in Example 1, with as the solvent, isopropyl alcohol (IPA), added to the strontium hydroxide (Sr(OH)₂) suspension from which the strontium carbonate crystals were obtained for the purpose of reducing the solubility of the crystals. The strontium carbonate crystals thus produced were observed using the SEM. The measurement results of various parameters are shown in Table 3.

### EXAMPLE 4

### Preparation of Carbonate Particles

Carbonate (barium carbonate) crystals were produced in a manner similar to that described in Example 1, with a 0.01M barium hydroxide (Ba(OH)₂) suspension used instead of the 0.01M strontium hydroxide (Sr(OH)₂) suspension. The barium carbonate crystals thus produced were observed using the SEM. The measurement results of various parameters are shown in Table 4.

### EXAMPLE 5

### Preparation of Carbonate Particles

Carbonate (zinc carbonate) crystals were produced in a manner similar to that described in Example 1, with a 0.01M zinc hydroxide (Zn(OH)₂) suspension used instead of the 0.01M strontium hydroxide (Sr(OH)₂) suspension. The zinc carbonate crystals thus produced were observed using the SEM. The measurement results of various parameters are shown in Table 4.

### EXAMPLE 6

### Preparation of Carbonate Particles

Carbonate (lead carbonate) crystals were produced in a manner similar to that described in Example 1, with a 0.01M lead hydroxide (Pb(OH)₂) suspension used instead of the 0.01M strontium hydroxide (Sr(OH)₂) suspension. The lead carbonate crystals thus produced were observed using the SEM. The measurement results of various parameters are shown in Table 4.

### COMPARATIVE EXAMPLE 1

### Preparation of Carbonate Particles

500 ml of a 0.5 M ammonium carbonate ((NH₄)₂CO₃) aqueous solution were added dropwise to 500 ml of a 0.5 M strontium nitrate (Sr(NO₃)₂) solution contained in a vessel. The resultant mixture was agitated to allow reaction to take place at 25° C. for 90 min. to produce strontium carbonate crystals. The agitation was conducted at 500 rpm.

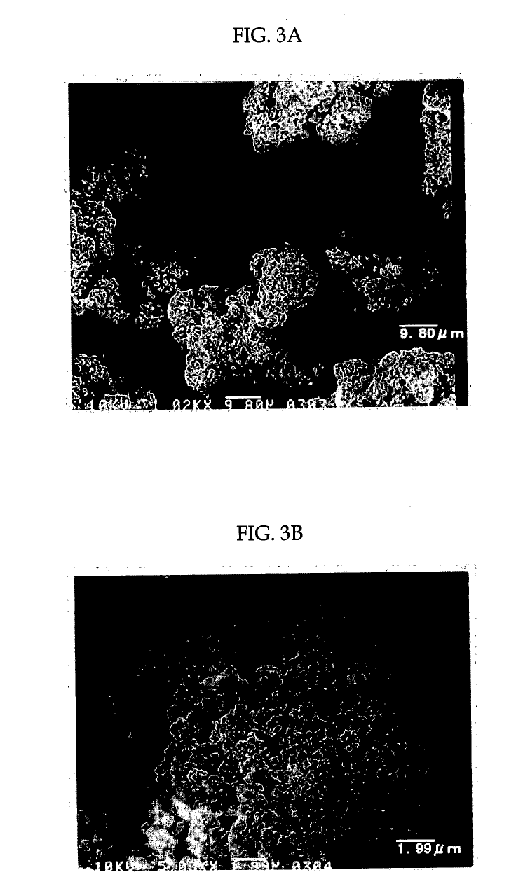

The strontium carbonate crystals thus produced were recovered by filtration and dried. The dried strontium carbonate crystals were observed using the SEM. A SEM pictures taken at this time are shown in FIGS. 3A and 3B. The magnifications of SEM pictures of FIGS. 3A and 3B are respectively 1,020 and 5,030. From this picture it was confirmed that the crystal aggregates of the strontium carbonate were obtained that have spherical shapes and have an average particle length of approximately 0.35 μm. In addition, the proportion of crystals with a length of average particle length ±α (where α is 0.1 μm) in the total crystals was 55%. The results are shown in Table 5.

### COMPARATIVE EXAMPLE 2

### Preparation of Carbonate Particles

Strontium carbonate crystals were produced in a manner similar to that described in Comparative Example 1, with 500 ml of a 0.01 M strontium hydroxide (Sr(OH)₂) suspension used instead of 500 ml of the 0.5M strontium nitrate (Sr(NO₃)₂) solution. The strontium carbonate crystals thus produced were observed using the SEM. The measurement results of various parameters are shown in Table 5.

### COMPARATIVE EXAMPLE 3

### Preparation of Carbonate Particles

Carbonate (strontium carbonate) crystals were produced in a manner similar to that described in Comparative Example 1, with as the solvent, isopropyl alcohol (IPA), added to the strontium nitrate (Sr(NO₃)₂) solution from which the strontium carbonate crystals were obtained for the purpose of reducing the solubility of the crystals. The strontium carbonate crystals thus produced were observed using the SEM. The measurement results of various parameters are shown in Table 5.

TABLE 3

| | Ex. 1 | Ex. 2 | Ex. 3 |
|---|---|---|---|
| Metal ion source | Sr(OH)₂ | Ca(OH)₂ | Sr(OH)₂ |
| Carbonate source | (NH₄)₂CO₃ | (NH₄)₂CO₃ | (NH₄)₂CO₃ |
| Solvent | Without | Without | With |
| | isopropyl | isopropyl | isopropyl |
| | alcohol | alcohol | alcohol |
| Particle shape | Rod-shaped | Rod-shaped | Rod-shaped |
| Aspect ratio | 5.5 | 2.8 | 3.9 |
| Average particle length | 470 | 710 | 384 |
| (nm) | | | |
| Proportion of carbonate | 67 | 44 | 62 |
| crystals with a length of | | | |
| average particle | | | |
| length ± α (%) | | | |

TABLE 4

| | Ex. 4 | Ex. 5 | Ex. 6 |
|---|---|---|---|
| Metal ion source | Ba(OH)₂ | Zn(OH)₂ | Pb(OH)₂ |
| Carbonate source | (NH₄)₂CO₃ | (NH₄)₂CO₃ | (NH₄)₂CO₃ |
| Solvent | Without | Without | Without |
| | isopropyl | isopropyl | isopropyl |
| | alcohol | alcohol | alcohol |
| Particle shape | Rod-shaped | Rod-shaped | Rod-shaped |
| Aspect ratio | 5.1 | 3.8 | 4.4 |
| Average particle length | 520 | 438 | 605 |
| (nm) | | | |
| Proportion of carbonate | 60 | 47 | 52 |
| crystals with a length of | | | |
| average particle | | | |
| length ± α (%) | | | |

TABLE 5

| | Compara. | Compara. | Compara. |
|---|---|---|---|
| | Ex. 1 | Ex. 2 | Ex. 3 |
| Metal ion source | Sr(NO₃)₂ | Sr(OH)₂ | Sr(NO₃)₂ |
| Carbonate source | (NH₄)₂CO₃ | (NH₄)₂CO₃ | (NH₄)₂CO₃ |
| Solvent | Without | Without | With |
| | isopropyl | isopropyl | isopropyl |
| | alcohol | alcohol | alcohol |
| Particle shape | Spherical- | Spherical- | Spherical- |
| | shaped | shaped | shaped |
| Aspect ratio | 1.0 | 1.0 | 1.0 |
| Average particle length | 0.35 | 2.7 | 1.2 |
| (μm) | | | |
| Proportion of carbonate | 55 | 61 | 48 |
| crystals with a length of | | | |
| average particle | | | |
| length ± α (%) | | | |

It was confirmed from the results shown in Tables 3 and 4 that the carbonate particles prepared in Examples 1 to 6 had pillar (rod) shapes, and had an aspect ratio of greater than 1. In particular, it was established that the production process conducted under the reaction condition of Example 3 resulted in the production of fine pillar-shaped carbonate particles with an average particle length of 384 nm. It was also established that the process of all of Examples 1 to 6 could control the particle size by the reaction at room temperature and that a high proportion of carbonate particles of a certain size could be obtained.

### INDUSTRIAL APPLICABILITY

The process for producing carbonate particles of the present invention can control the particle size and thus can efficiently and readily produce carbonate particles containing a high proportion of carbonate particles of a certain size.

The carbonate particles produced by the process of the present invention are particles which have high crystallinity, are less prone to agglomeration and have an aspect ratio of greater than 1. In particular, in the case of the carbonate particles that are needle- or rod-shaped, variations in the orientation of particles in the resulting molded article are small and thus the mold article becomes isotropic, making it useful for reinforcing materials for plastics, frictional materials, heat insulating materials, filters, and the like. When the carbonate particles are used for shape-changed composite materials such as drawing, aligned particles therein can increase their strength and improve their optical characteristics.

Moreover, when the carbonate particles, or carbonate crystals, produced by the process of the present invention are dispersed into an optical polymer having a birefringence followed by a drawing process for allowing linking chains present in the optical polymer and the carbonate crystals to align in a direction substantially parallel to each other, the birefringence due to the optical anisotropy in the linking chains can be canceled by the birefringence of the carbonate crystals. For this reason the optical polymer added with such carbonate particles can be suitably used for optical components, particularly optical elements where polarization characteristics are of importance and high precision is required.

1. A process for producing carbonate particles, comprising:
releasing a carbon dioxide gas from a carbonate source into a gas phase,
dissolving the carbon dioxide gas in a liquid containing a metal ion source to produce carbonate particles having an aspect ratio of greater than 1,
wherein the metal ion source contains at least one metal ion selected from the group consisting of Sr²⁺, Ca²⁺, Ba²⁺, Zn²⁺ and Pb²⁺.

2. The process for producing carbonate particles according to claim 1, wherein the carbonate particles are needle- or rod-shaped.

3. The process for producing carbonate particles according to claim 1, wherein the metal ion source is at least one hydroxide of a metal selected from the group consisting of Sr, Ca, Ba, Zn, and Pb.

4. The process for producing carbonate particles according to claim 1, wherein the carbonate source is in a solid state or a gas state.

5. The process for producing carbonate particles according to claim 4, wherein the carbonate source is a solid ammonium carbonate.

6. The process for producing carbonate particles according to claim 1, wherein the carbon dioxide gas is released in a closed vessel.

7. The process for producing carbonate particles according to claim 1, wherein the liquid contains water.

8. The process for producing carbonate particles according to claim 1, wherein the liquid contains a solvent.

9. The process for producing carbonate particles according to claim 8, wherein the solvent is at least one selected from the group consisting of methanol, ethanol, and isopropyl alcohol.
